(19) United States
(12) Patent Application Publication
(10) Pub. No.: US 2003/0182377 A1
(43) Pub. Date: Sep. 25, 2003

(54) Flexible routing engine

(76) Inventors: Paul M. Tabet, Danville, CA (US); Andrew D. Harnett, Oakland, CA (US); Ryan G. Nagahori, Dubbin, CA (US)

Correspondence Address: KOLISCH HARTWELL, P.C., 520 S.W. YAMHILL STREET, SUITE 200, PORTLAND, OR, 97204, US

(21) Appl. No.: 10/365,136

(22) Filed: Feb. 11, 2003

Related U.S. Application Data
(60) Provisional application No. 60/356,887, filed on Feb. 12, 2002.

(51) Int. Cl. G06F 15/16

(52) U.S. Cl. 709/205; 709/206

(57) ABSTRACT

A method of facilitating collaboration and communication between individuals. According to the present invention, various different types of communications may be routed via a communication network having a modular framework. The method utilizes interchangeable modules that are each configured to facilitate a specific type of communication, such as a price quote, split commission, return merchandise authorization, product change notice, engineering change notice, vacation approval, meeting schedule, etc. A module may be configured to facilitate virtually any type of communication. The modular framework of the present invention permits different types of modules to be flexibly routed using the same method, regardless of the underlying content of the module.

### CROSS-REFERENCE TO RELATED APPLICATIONS

This application is based upon and claims priority under 35 U.S.C. § 119 from the following co-pending U.S. provisional patent application, which is incorporated herein by this reference, in its entirety and for all purposes: “Flexible Routing Engine,” Serial No. 60/356,887, filed Feb. 12, 2002.

### TECHNICAL FIELD

The present invention generally relates to computerized communication, and more particularly relates to methods of flexibly routing modular communications via network communication systems.

### BACKGROUND OF THE INVENTION

In collaborative environments, groups of people work together to solve problems, complete tasks, and share information. Often times, similar problems and tasks reoccur and the same type of information needs to be shared. As a result, people within a group often repeat similar activities over and over. Some groups try to anticipate the repetition and implement workflow processes designed to streamline repetitive activities and increase the overall efficiency at which the group works. The ability to modify a workflow process often decreases as the process is engineered to be increasingly streamlined and automated. In particular, computer implemented workflow processes traditionally have been designed to eliminate a human's ability to introduce variables into the workflow. When such systems encounter an unpredicted event, the process fails and cannot be easily adapted to work around the unpredicted event. Removing the human element from workflow processes prevents a person from troubleshooting the process to circumvent unforeseen events as they arise. In exchange for a structured process, the ability of actual people to make decisions is sacrificed.

Another problem with some computer-implemented processes is the complexity of setting up the processes. A skilled programmer is often required to implement a particular process. Most of the time, the programmer is not even a participant to the process, and therefore, does not understand the numerous uncertainties that may cause the process to deviate from an anticipated course. Even the participants most familiar with the process cannot anticipate every possible uncertainty, deviation, or bottleneck that may limit the usefulness of an inflexible process. When a workflow process deviates from the anticipated course, the process fails, and the programmer must reengineer the process to account for the newly discovered variable. The reengineered process remains vulnerable to additional unpredicted events.

What is needed is a system and method that may be used to add flexibility to any process. In particular, it would be desirable to allow the actual participants to a process to make decisions and problem solve around unanticipated events. Furthermore, it would be desirable if such a system and method was easy to implement by the process participants and required limited interaction from outside sources.

### SUMMARY OF THE INVENTION

A method of facilitating collaboration and communication between individuals is provided. According to the present invention, various different types of communications may be routed via a communication network. The method utilizes interchangeable modules that are each configured to facilitate a specific type of communication or process, such as a price quote, split commission, return merchandise authorization, product change notice, engineering change notice, vacation approval, meeting schedule, etc. A module may be configured to facilitate virtually any type of communication. The modular framework of the present invention permits different types of modules to be routed using the same method, regardless of the underlying content of the module.

Modules may be routed to one or more participants in a flexible manner. A process originator initiates a communication by establishing an access definition that specifies a module to be routed, the individuals the module is to be routed to, and the conditions upon which each individual is to be routed the module. When the specified conditions have been satisfied for a particular individual, that individual may access the module via a network. The access definition may be subsequently modified and the module may then be routed according to the modified access definition.

Some embodiments of the present invention allow for improved process visibility. During a routing, authorized participants may view information regarding the routing, such as the time each participant takes to act, the information each participant submits, etc. Furthermore, routing metrics may be accumulated to facilitate analysis of various processes.

### BRIEF DESCRIPTION OF THE DRAWINGS

FIG. 1 is a schematic view of a computerized communication system configured to execute the present invention.

FIG. 2 is a schematic view of a form configured to receive information according to the present invention.

FIG. 3 is a schematic view of a user interface configured to facilitate the selection of a module for routing in accordance with the present invention.

FIG. 4 is a schematic view of a user interface configured to facilitate selection of a participant set.

FIG. 5 is a schematic view of a user interface configured to facilitate selection of an access schedule.

FIG. 6 is a schematic view of an access definition initialized via the user interfaces of FIGS. 3-5.

FIG. 7 is a schematic view of a modified access schedule.

FIG. 8 is a schematic view of a further modified access schedule.

FIG. 9 is a flowchart showing a method of facilitating communication.

### DETAILED DESCRIPTION OF THE INVENTION

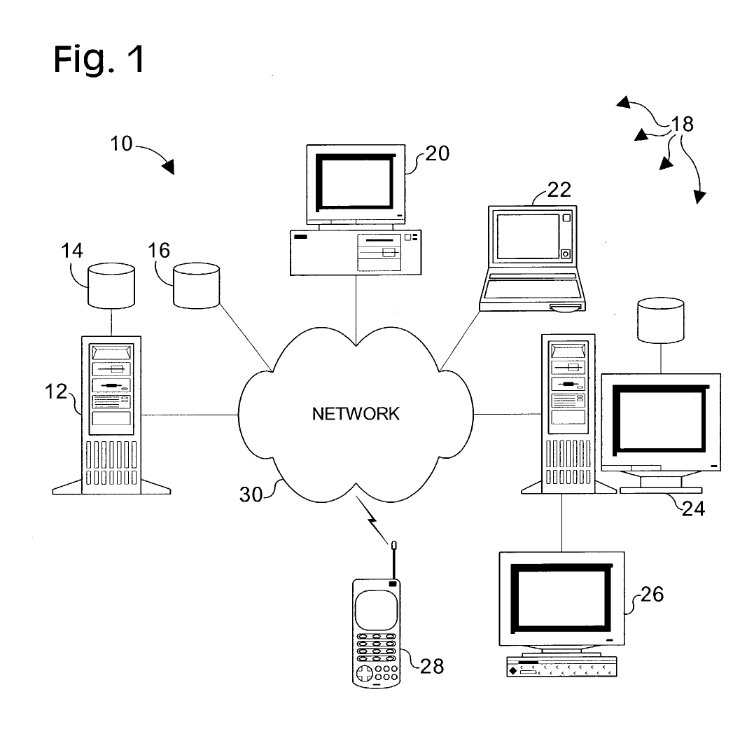

FIG. 1 shows an exemplary communication system 10 that is configured to facilitate flexible communication and collaboration between various participants in accordance with the present invention. Communication system 10 may be configured so that an individual may utilize the communication system to route a flexible communication to one or more individuals with access to the system. For example, a worker may send a request for a price quote to three colleagues. According to the present invention, the worker may grant the colleagues varying levels of access to the request. For example, one colleague may be allowed to view the request but not submit any comments, while another colleague may view the request and submit a price quote as well as other comments. Furthermore, one or more of the colleagues may be granted permission to add, subtract, or otherwise modify recipients scheduled to receive the quote. Such additions, subtractions, and modifications may even be made after the original request is initiated and routed to a recipient.

Communication system 10 may be configured to facilitate various different types of communications. In particular, the communication system may be configured to provide one or more participants scheduled access to a module. As described in detail below, a module is an interchangeable collection of information, which may be shared amongst various participants. Virtually any module may be shared, regardless of its underlying content or function. The communication system may be configured to allow the module to be shared in a flexible manner, which is adaptable to unforeseen events.

In the depicted embodiment, communication system 10 includes a server 12, private database 14, public database 16, and at least one participant device 18 such as desktop computing device 20, laptop computing device 22, gateway computing device 24, network computing device 26, and mobile computing device 28. Server 12 and the various databases and participant devices communicate via a network 30, such as the Internet. In particular, server 12 is usually configured to send and receive information and instructions to and from the participant devices and databases. Server 12 and the participant devices may interface with network 30 via a variety of mechanisms. In the depicted embodiment, for example, desktop computing device 20 directly connects to network 30 while network computing device 26 is part of an internal network connected to network 30 via gateway computing device 24. Mobile computing device 28 connects to network 30 via a wireless data transmission mechanism such as a cellular network. Servers, databases, participant devices, and/or other computing devices may include an internal storage medium or be configured to receive a removable storage medium. Such storage mediums may include instructions that, when executed, result in the computing device having the capability of facilitating communication in accordance with the present invention, as described in detail below. It should be understood that flexible routing is compatible with virtually any computing device or network communication mechanism and the above devices and network communication mechanisms are provided as examples for the purpose of explaining the present invention.

Users of a participant device 18, such as those depicted in FIG. 1 or any other suitable participant device, may communicate with one another via a network, such as network 30. In particular, the users may use electronic mail, instant messaging, chat, video conferencing, voice over IP, or bulletin boards. These and other communication mechanisms may be appropriate for simple nonscheduled communications in which all participants are to have equal access to the underlying content of the communication. However, in some instances, the order in which participants access the communication may be important. Other times, it may be desirable to grant the various participants different levels of access to the communication. For instance, it may be desirable to grant some participants access to view the communication but not alter it, while other participants may be granted access to alter the communication or even cancel the communication. In such situations, communication mechanisms developed heretofore have proven to be unsatisfactory.

The present invention uses a modular framework so that various different types of communications may be flexibly routed. The content of each different type of communication is stored in a module configured for flexible routing. Modules provide a building block around which processes may be designed. For example, modules may be individually configured to facilitate processes such as price quotes, split commissions, return merchandise authorizations, product change notices, engineering change notices, vacation approvals, meeting schedules, etc. A module may be configured to accomplish virtually any task, and the examples provided herein should not be construed as limiting the present invention to such examples.

A module may include content stored in virtually any file format for virtually any computing platform. For example, modules may be stored as text documents, word processing documents, database documents, spreadsheet documents, scanned documents, html documents, xml documents, etc. Either standard or proprietary formats may be used. It is also within the scope of the invention to route modules that have completely different formats relative to one another.

Some modules may receive content for storage via one or more forms specifically configured to receive information relating to a particular process. For example, FIG. 2 schematically depicts an illustrative form, price quote form 40, that is configured to track price quotes from one or more participants. The form includes participant cells 42 configured to receive the names of each participant submitting a quote. Part cells 44 are provided to receive the parts being quoted, and price cells 46 receive the quoted prices from each participant. Additional cells, such as comments cell 48, may be provided to receive additional information, such as comments regarding the availability of certain parts, discounts for high volume purchases, alternative parts, etc. Forms may be individually configured to accommodate virtually any information, and forms may be adaptable so that after creation they may be modified to store alternative and/or additional information. In the depicted embodiment, price quote form 40 is configured to receive information from plural participants. It is also within the scope of the invention to configure forms to receive information from a single participant, and information from such forms may be collectively stored and/or displayed with similar information via another form and/or report.

The cells may be configured to receive input from participants and/or other sources. Forms provide a user friendly interface, and the content received by the forms may be used to populate one or more databases. The information received by a form may be electronically indexed to facilitate easy searching and retrieval. The contents of one or more forms may be channeled to a database to permit the contents of one or more forms to be individually analyzed or analyzed in relation to other forms (modules). Similarly, the information may be used to create diagnostic reports, statistical metrics, etc.

The present invention allows users to easily initiate a process that is specifically configured to accomplish a particular task. As used herein, the term “process originator” is used to describe any user that initiates such a process. Any authorized individual may act as a process originator. The process originator may define the manner by which a module shall be routed by initializing an access definition. As used herein, the term “access definition” refers to one or more parameters that at least partially define the flow of a corresponding process. An access definition may include an identifier indicating the module that is scheduled for access, the identity of participants scheduled to receive the module, the conditions upon which each participant shall receive the module, and/or other details associated with the corresponding process.

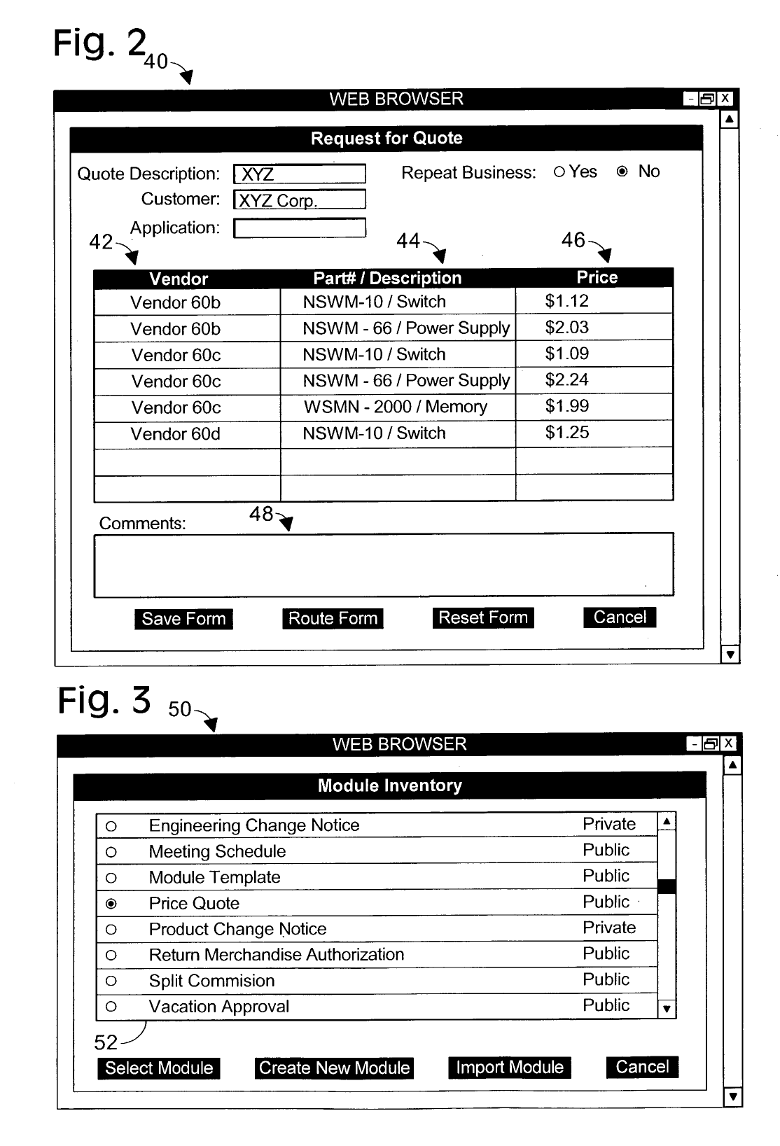

FIG. 3 shows an exemplary user interface 50 configured to allow a process originator to select a module for routing. A module inventory 52 provides the process originator with preconfigured modules that may be selected. The process originator may search the module inventory for a suitable module, and if such a module is found, the process originator may select it for routing. For example, this may be accomplished by highlighting the appropriate module in the module inventory and activating the “Select Module” button. If a suitable module does not exist, the process originator may create an appropriate module by activating the “Create New Module” button. Modules may range in complexity from a simple scanned document to a complex form adapted to receive and store information from participants, automated databases, and/or other information repositories. The process originator may lock the module so that it may only receive specified information, or the process originator may selectively leave portions of the module unlocked so that selected participants can modify the module to receive alternative and/or additional information.

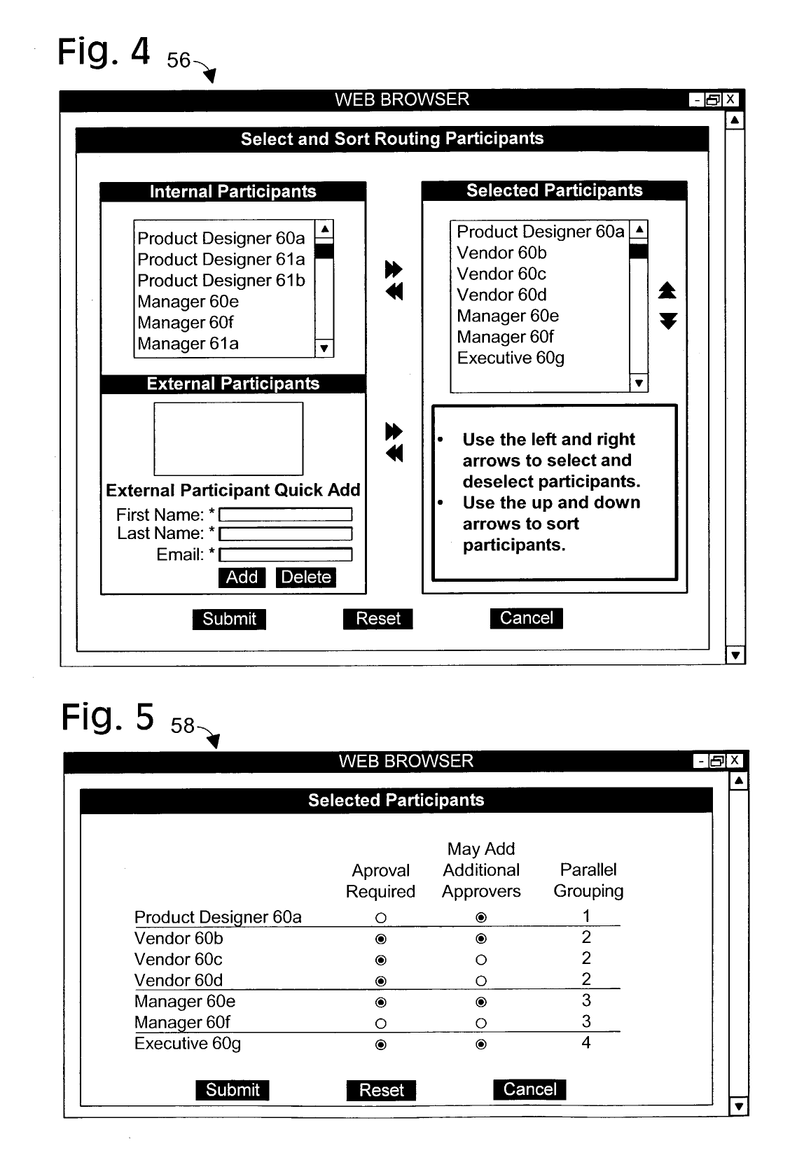

FIG. 4 shows an exemplary user interface 56 configured to allow the process originator to specify a participant set, which identifies the participants scheduled to receive access to the module. Such an interface may also be used to specify an access schedule, which includes the conditions that must be satisfied before each particular participant is granted access to the module. As shown, participants may be selected from a list, such as the “Internal Participants” list, or individually added, such as via the “External Participants” fields. Once selected, the participants may be moved to the “Selected Participants” list via the left and right arrows. The participant set may be set from the “Selected Participants” list by activating the “submit” button.

It is within the scope of the invention to utilize interfaces that allow for increased control and may be used to specify intricate access schedules. Similarly, an interface, such as interface 56, may be utilized to specify a relatively simple access schedule, in which the order that the various participants are routed the module is set. As shown, the order may be selected by ordering the participants after they are selected, such as by using the provided arrows to arrange the participants in the “Selected Participants” list. An access schedule may be specified using one or more interfaces, depending on the intricacy of the desired access schedule.

FIG. 5 shows user interface 58 that is configured to further specify the access definition. In particular, user interface 58 is configured to allow the process originator to specify whether each participant is required to take action on the process by toggling a “Approval Required” button. The interface also allows the process originator to specify whether the participants are permitted to add additional participants to the routing by toggling a “May Add Additional Approvers” button. Furthermore, the process originator may specify that certain participants receive the routing at the same time by assigning them the same “Parallel Grouping” value. The above are examples of the types of control that may be specified by the access definition, but are not meant to be limiting.

The access definition may be modified in a flexible manner so that after a process originator initiates a process, the process may be adapted by the process originator and/or an authorized participant or third party. One or more user interface may be configured to facilitate such modifications. The access definition may be modified to adapt a process in real-time after the process is initiated. For example, if a participant does not take action necessary for a pending process to proceed, the participant may be removed from the process so that the rest of the participants are not prevented from completing their tasks. If an existing participant feels that a third party should be brought into the process, the existing participant may add the third-party participant to the process. Of course, these are only examples of the kinds of adaptations that may occur, and should not be considered as limiting the present invention. The amount and types of flexibility and the parties authorized to modify the access definition may be determined by the process originator or other authorized parties.

The utility of the present invention may be appreciated by tracking an exemplary process, such as a request for a price quote. In particular, the following example tracks a price quote in which a product designer (60a) requests three vendors (60b, 60c, and 60d) to submit a quote on three different parts required to manufacture a device. After the vendors have submitted their respective quotes, the quotes must be approved by a middle manager (60e) before being finally approved by the companies vice president of design (60g). In addition, the product designer wants his manager (60f) to see the quotes after they are submitted, but does not want the manager to take any action on the quotes.

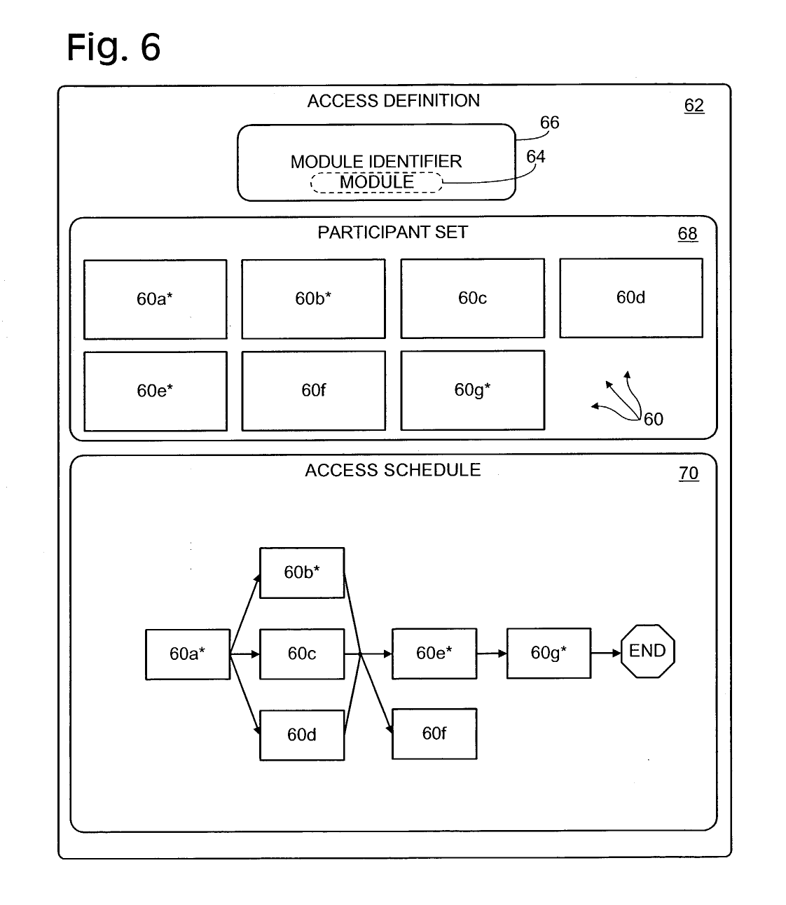

The product designer (process originator) initiates the process by initializing an access definition 62, which is schematically depicted in FIG. 6. User interfaces, such as those shown in FIGS. 3-5, may be used to initialize the access definition. Using such interfaces, or by another suitable mechanism, the product designer may select a module 64 that is configured to receive and store a submitted price for each of the three parts required to make the desired product, for example, as shown in FIG. 3. Module identifier 66 is a pointer that uniquely identifies module 64 and may be used to select the module. The product designer may select the module from a module inventory comprising a variety of modules configured to assist in various tasks (or module identifiers pointing to such modules). Such a module inventory may be stored locally on a participant device or may be accessed remotely via a network. If a suitable module is not available in the module inventory, the product designer may create an appropriate module. After creation, such modules may be automatically added to the module inventory, the designer's private inventory, another suitable database, or may alternatively be deleted.

The product designer also specifies a participant set 68 that includes participants 60 to the process, for example, via user interface 56 of FIG. 4. In the depicted embodiment, the participant set includes product designer 60a, vendors 60b, 60c, and 60d, middle manager 60e, product manager 60f, and executive 60g. Participants may be selected from a directory of participants that have previously been identified as potential participants. As used herein, such participants are referred to as being “internal” participants. For example, the internal participants may include a listing of all the employees of a company as well as frequently used vendors, contractors, etc. However, the present invention is not limited to routing a module to a predetermined finite set of internal participants. The process originator may include additional participants to the process even if they are not included in a directory of internal participants. Such participants are referred to as “external” participants. A module may be routed to any participant that is locatable on a network, such as by an electronic mail address or an Internet protocol (IP) address.

An access schedule 70 is created by the process originator in order to establish the conditions upon which each participant is granted access to the module, for example, via user interfaces 56 and 58 of FIGS. 4 and 5. As used herein, “granting access to a module” may mean that a user has been notified of a module's existence, has been given read access to inspect the contents of the module, has been given read/write access to inspect the module's contents and/or change the contents, etc. The access definition may provide for sequential access, parallel access, iterative access, etc.

Different participants may be granted different levels of access. For example, in the depicted embodiment the module is to be simultaneously routed to vendors 60b, 60c, and 60d so that they may individually submit price quotes on three parts required to produce the desired product. This type of simultaneous routing is referred to as parallel routing, meaning that the participants are simultaneously granted access to the module. After the three quotes are submitted a condition established by the access definition is satisfied, and the module is to be simultaneously routed to middle manager 60e and product manager 60f. Routing that is condition based, such as this, is referred to as sequential routing, meaning that one participant is only granted access to the module after another participant has been granted access (and possibly has given participant approval to the module).

Product manager 60f is not required to take any action, but is granted access to inspect the module. Therefore, the product manager is referred to as an observer. On the other hand, middle manager 60e must approve the prices submitted by vendors 60b, 60c, and 60d before the process moves forward. Therefore the middle manager is referred to as an approver. Executive 60g is established as the final approver and must approve the price quotes before the process is completed. Any of the participants may be internal or external participants. The above access schedule is intended to be exemplary, and other access schedules may of course be used.

The process originator (or other user with adequate privileges) may provide one or more of the participants with authority to modify the access definition before and/or after the process has been initiated, for example, via user interface 58 of FIG. 5. Different participants may be granted varying levels of control, but for the sake of simplicity the present example will assume that participants either may not change the access definition at all or may alternatively make any desired change to the access definition. In the depicted embodiment, participants authorized to make changes are identified with an asterisk, such as 60a* and 60b*.

Continuing to use the example set forth above, the product designer may route module 64 to vendors 60b, 60c, and 60d so that they may provide their respective price quotes, for example, via price quote form 40 of FIG. 2. When a module is routed to one of the participants, such as vendor 60b, that participant is automatically notified of the routing. It is within the scope of the invention to notify a participant via various mechanisms, including e-mail, electronic bulletin board, pager, voice mail, etc. In some embodiments, such as e-mail or bulletin board notifications, the notification may include a link that directs the participant to the routed module, which may electronically reside on a remote computing system. Storing the actual module on a remote computing system allows the changes that one participant makes to the module to be viewed by other participants. Plural participants may make changes at the same time and have the changes reflected in real-time so that other participants may instantly view the changes. In some embodiments, the contents of the module are actually sent to the participant. This may be useful, for instance, if the participant does not have continuous access to a network, and wants to work on a module while offline. Such modules may be configured to automatically synchronize with a network module when the participant goes back online.

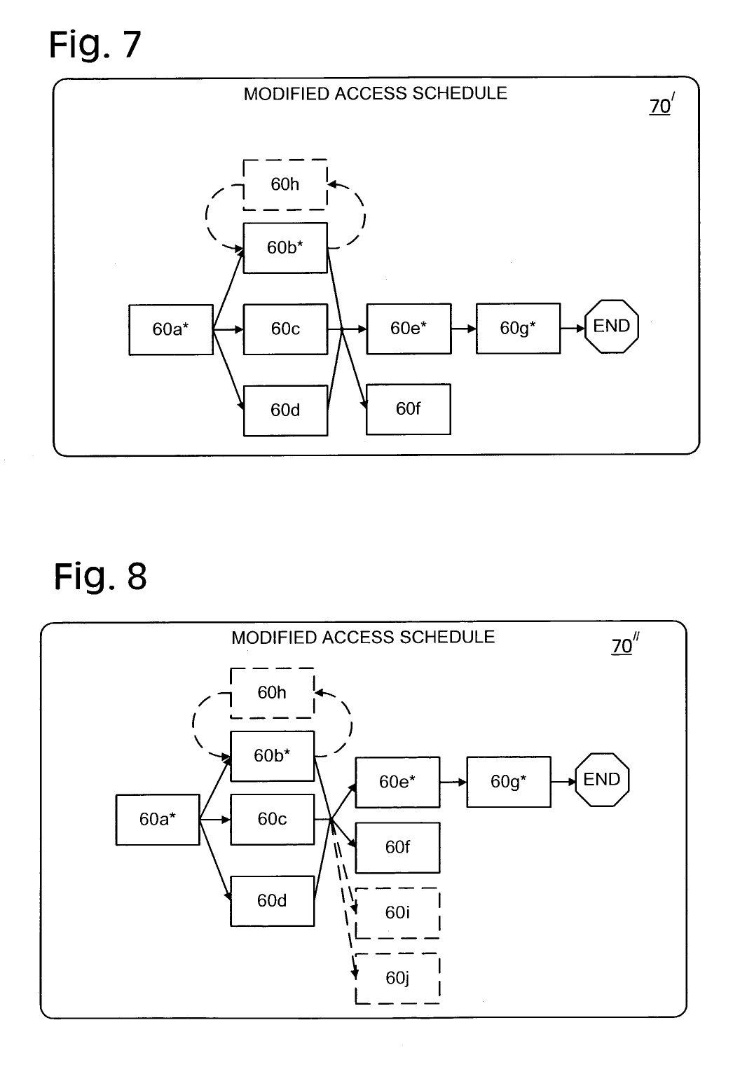

The present invention provides for flexible routing. For example, vendor 60b may add supplier 60h to participant set 68 if vendor 60b does not have the information or authority to quote a price. FIG. 7 shows modified access schedule 70′, which results from such a modification. Vendor 60b may add supplier 60h without disrupting the remainder of the process. For example, vendors 60c and 60d may give their price quotes without being affected by the addition of supplier 60h. When supplier 60h gives a price quote, it is routed back to participant 60b for approval and then to participants 60e and 60f. This type of routing is referred to as iterative routing. Vendor 60b may have alternatively altered access schedule 70 to route the supplier's price quote directly to middle manager 60e and product manager 60f without returning to vendor 60b. Participants may be authorized to modify the access definitions to varying degrees, and some participants may be authorized to make substantial modifications, such as to suspend or cancel a process. Similarly, some participants may be granted less authority, and may, for instance, make limited changes, such as adding an additional approver. It is within the scope of the invention to authorize different participants to make different types of modifications.

As exemplified by product manager 60f, all participants are not required to take action in order for the process to move forward. The arrow leading into product manager 60f indicates that the product manager is granted access to module 64. However, no arrow leaves the product manager, indicating that the product manager is not required to take any action for the process flow to move forward. An arrow does leave middle manager 60e, which indicates that the middle manager must approve the price quote (or otherwise take action) for the process flow to continue. Participants that are not required to take action are herein referred to as “observers.” Granting module access to observers may be desirable in order to allow some participants that are not required to provide information or approval to stay informed of the process as it is occurring. Plural observers may be specified for each process, and an observer may be provided access to a module during different phases of a process. Furthermore, active participants that are required to take action, such as approvers, may be converted into observers and vice versa.

In the depicted embodiment, middle manager 60e is an approver who must approve the prices submitted by vendors 60b, 60c, and 60d before the process moves forward. Because middle manager 60e was given authority to change access definition 62, the middle manager may add participants 60i and 60j, as indicated by modified access schedule 70″ in FIG. 8. Like product manager 60f, participants 60i and 60j are observers, and thus are not required to take any action for the process to move forward. Therefore, when middle manager 60e approves the prices submitted by vendors 60b, 60c, and 60d, module 64 is routed to executive 60g for final approval. Executive 60g may inspect module 64 to determine if final approval is appropriate. If the quoted prices are unsatisfactory, executive 60g may alter the access definition and send the module back to previous participants and/or add new participants to the process. However, in the depicted embodiment, executive 60g grants approval and the process ends.

The above example illustrates the utility of the present invention. Because of its modular framework, the present invention may route virtually any type of communication, and the request for a price quote is only provided as one possibility. Similarly, the flexibility of the present invention allows for other modifications to be made to the access definition, and the above modifications are only examples of the types of modifications that are possible.

Some embodiments of the present invention allow authorized participants, and/or other authorized individuals, to have visibility into a process before, during, and/or after routing of a module. Authorized individuals have access to information regarding the routing of a module, such as which participants have viewed a module, how long each participant takes to act on the module, the net time it takes for all participants to complete a process, the actual information that the participants submit, etc. For example, a manager may check how long a particular vendor takes to respond to a price quote, and if the vendor takes too long, the manager may modify the access definition to remove that vendor from the process.

Data from one or more processes may be accumulated and used to formulate report metrics that may be used to analyze the processes. For example, the average time it takes to perform a request for price quote (or other process) may be tracked. Furthermore, such information may be combined with other information allowing for more thorough analysis. For example, the percentage of product designs that are approved by customers may be compared to the time it took for a series of price quote authorization process to be completed. Such statistical information may be used to identify key aspects of processes that may be improved. The statistical information may also be used to determine the efficiency of different participants, groups of participants, modules, etc. Because of the flexible modular framework of the present invention, different types of statistical analysis may be easily initiated for various processes. If a particular analysis has not been created for a certain process, it may easily be created and implemented. Furthermore, such an analysis may be easily adapted to work with other modules.

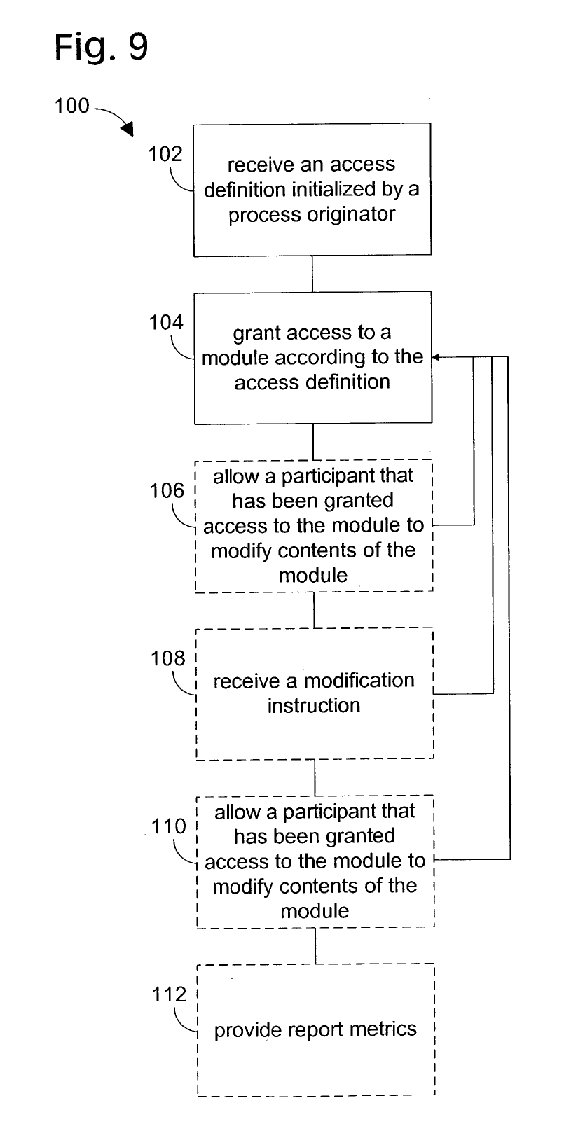

FIG. 9 shows, generally at 100, a method of facilitating communication in accordance with one embodiment of the present invention. Method 100 includes, at 102, receiving an access definition initialized by a process originator. The access definition is typically received by a server via a network such as the Internet. The access definition typically is initialized by a process originator using one or more user interfaces on a participant device, as described above.

At 104, the method further includes granting access to a module according to the access definition. Access is typically granted to one or more participants to a particular process for which the communication is being routed. Granting access typically includes notifying the participant of the routing, and allowing the participant to remotely access a module. In some embodiments, the module is instead sent to the participant for local access. As shown at 106, the method may also include allowing a participant that has been granted access to the module to modify the contents of the module. In this manner, a participant may submit information, and/or alter information submitted by another participant.

At 108, the method may further include receiving a modification instruction that may alter the access definition. The modification instruction can change the routing of the module, and thus alter the process for which the module is being routed. Because the process may be altered after it has been initiated, the process is flexible and may be adapted to unforeseen events. The modification instruction may be submitted by a participant, including the process originator, or another individual with appropriate authority.

As shown at 110, a participant may modify the contents of a module after a modification instruction has been received. Furthermore, access may be granted to a participant after the modification instruction has been received and/or after a participant has modified the contents of the module. Different participants may be granted access to the module at different times.

At 112, the method may further include providing report metrics. As described above, report metrics may be calculated using information accumulated during the routing of a module, such as the average time a participant takes to act, the average duration a particular process is active before completion, the average number of changes made to an access definition during a routing, etc. Virtually any type of statistical analysis may be performed and provided via the report metrics. The report metrics are provided to facilitate analyzing a process or participant and may be used to improve the process.

While the invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

We claim:

1. A method of flexibly routing network communications via a communication system, the method comprising:
receiving an access definition initialized by a process originator, wherein the access definition includes:
a module identifier indicating a module scheduled for participant access,
a participant set specifying one or more participants scheduled to receive access to the module, and
an access schedule defining, for each participant, conditions that must be satisfied before module access is granted to the participant; and
granting access to the module according to the access definition.

2. The method of claim 1, further comprising receiving a modification instruction, wherein the modification instruction modifies the access definition.

3. The method of claim 1, wherein access is granted to the module according to the modified access definition.

4. The method of claim 2, wherein the modification instruction is initialized by one of the participants.

5. The method of claim 2, wherein the modification instruction is received subsequent to granting module access to at least one of the participants.

6. The method of claim 2, wherein the modification instruction modifies the module identifier.

7. The method of claim 2, wherein the modification instruction modifies the participant set.

8. The method of claim 2, wherein the modification instruction modifies the access schedule.

9. The method of claim 1, further comprising allowing a participant that has been granted access to the module to modify contents of the module.

10. The method of claim 9, wherein the modified contents of the module are provided to participants that have been granted access to the module.

11. The method of claim 1, wherein the module is one of a plurality of modules, each configured to facilitate a different process.

12. The method of claim 1, wherein the module includes a form configured for receiving information from one or more sources.

13. The method of claim 12, wherein at least one of the one or more sources is one of the participants.

14. The method of claim 12, wherein at least one of the one or more sources is an information repository.

15. The method of claim 14, wherein the information repository is an electronic database.

16. The method of claim 1, wherein at least one of the participants is an external participant.

17. The method of claim 1, wherein one of the conditions defined by the access schedule is participant approval.

18. The method of claim 1, wherein the access schedule enables sequential access.

19. The method of claim 1, wherein the access schedule enables parallel access.

20. The method of claim 1, wherein the access schedule enables iterative access.

21. The method of claim 1, further comprising providing report metrics.

22. The method of claim 1, wherein one of the participants is the process originator.

23. The method of claim 1, wherein granting access to the module includes permitting remote access to the module.

24. The method of claim 1, wherein granting access to the module includes transmitting the module for local access.

25. The method of claim 24, wherein the module transmitted for local access is configured for synchronization with a remotely located module.

26. A method of flexibly routing network communications via a communication system, the method comprising:
receiving a request to route a module according to an initial access schedule;
initially routing the module according to the initial access schedule;
receiving a request to route the module according to a modified access schedule; and
subsequently routing the module according to the modified access schedule.

27. The method of claim 26, wherein routing the module includes granting a participant access to the module via a network.

28. The method of claim 26, wherein the module is one of a plurality of modules configured for routing, each module designed to facilitate a different process.

29. A storage medium including instructions that, when executed, result in a computing device having the capability of:
receiving an access definition initialized by a process originator, wherein the access definition includes:
a module identifier indicating a module scheduled for participant access,
a participant set specifying one or more participants scheduled to receive access to the module, and
an access schedule defining, for each participant, conditions that must be satisfied before module access is granted to the participant; and
granting access to the module according to the access definition.

30. A method of flexibly routing network communications via a communication system, the method comprising:
receiving an original access definition initialized by a process originator, wherein the original access definition includes:
a module identifier indicating a module scheduled for participant access,
a participant set specifying one or more participants scheduled to receive access to the module, and
an access schedule defining, for each participant, conditions which must be satisfied before module access is granted to the participant;
initially granting access to the module according to the original access definition;
receiving a modified access definition, wherein the modified access definition is reinitialized by one of the participants and includes at least one of a modified module identifier, modified participant set, and modified access schedule; and
subsequently granting access to the module according to the modified access definition.

31. The method of claim 30, further comprising allowing a participant that has been granted access to the module to modify contents of the module.

32. The method of claim 31, wherein the modified contents of the module are provided to participants that have been granted access to the module.
